(19) United States
(12) Patent Application Publication
(10) Pub. No.: US 2025/0273234 A1
(43) Pub. Date: Aug. 28, 2025

(54) TONE ARM SYSTEM

(71) Applicant: Airon Audio, LLC, Allentown, PA (US)

(72) Inventors: Julian Aaron Lesko, Fogelsville, PA (US); Paul Aaron Lesko, Allentown, PA (US)

(21) Appl. No.: 19/055,100

(22) Filed: Feb. 17, 2025

Related U.S. Application Data
(60) Provisional application No. 63/557,600, filed on Feb. 26, 2024.

(51) Int. Cl. G11B 3/12; G11B 3/16; G11B 3/22

(52) U.S. Cl. CPC G11B 3/121; G11B 3/16; G11B 3/22

(57) ABSTRACT

A tone arm apparatus comprising a hemispherical air bearing in a pivoted tone arm operable on all axes so as to provide a virtually frictionless bearing operative on the tone arm, thereby enabling a stylus and cartridge that converts vibrations in the record groove to electrical signals, to transmit the signals without unwanted bearing noises impacting upon the sound quality of the transmission.

### CROSS-REFERENCE TO RELATED APPLICATIONS

This patent application claims priority benefit under 35 U.S.C. § 119 to Provisional patent application Ser. No. 63/557,600 filed on Feb. 26, 2024, the subject matter of which is hereby incorporated by reference in its entirety.

### FIELD OF THE INVENTION

This invention relates generally to phonograph systems, and more particularly, to a tone arm apparatus and system having a hemispherical air bearing in a pivoted tone arm operable on all axes so as to provide a virtually frictionless bearing operative on a tone arm which enables a cartridge and its stylus to play a record with negligible bearing noise impact on sound quality.

### SUMMARY

According to an aspect of the disclosure, a tone arm apparatus and system comprises a hemispherical air bearing in a pivotable tone arm operable on all axes so as to provide a virtually frictionless bearing operative on the tone arm, thereby enabling a stylus and cartridge that converts vibrations in the record groove to electrical signals, to transmit the signals with significant reduction in bearing noises impacting upon the sound quality of the transmission.

According to a further aspect of the disclosure, a pump is coupled to the tone arm system to provide a regulated fluid (air) pressure to lift and/or maintain the tone arm. While the degree of pressure tends to change the film of air on which the tone arm rides, the pump according to an aspect of the present disclosure includes a compressor adapted to tightly control lift of a lightweight tone arm. The tone arm according to the present disclosure is very light, and therefore requires extremely low pressure to lift. Laboratory instruments in this category use a measurement in inches of water to show lift of water against gravity. In an exemplary embodiment, the tone arm lifts with only a few inches of water. In accordance with aspects of the present disclosure, the pressure of the system is dependent on various factors, including the bearing diameter and weight of the upper assembly. Material changes such as cartridge weight, arm length, and various other factors may cause changes to the operating pressure and tone arm lift. According to an embodiment of the disclosure, the compressor pump operates to provide the requisite lift of a few inches, while regulating the pressure and comprising an air chamber (e.g. sealed polyethylene or plastic compartment) configured to substantially reduce unwanted pressure pulsation (noise) from the air supply. In an embodiment, a flow regulator such as a needle valve may be used to adjust the pump pressure received into the air chamber. In an embodiment, a dimming circuit may be implemented upstream of the diaphragm pump for reducing the voltage fed to the pump and thereby reducing the pressure, external noise amplitude of pressure pulsations at the pump output. A pressure gauge or pressure sensor such as a manometer, may be configured to display to an end user the amount of pressure that is being applied.

According to a further aspect of the disclosure, a flexible, elongated tube couples an output port of the air chamber to an input port of the socket member for conveying or communicating the air pressure in order to generate the film of air on which the tone arm rides. In an embodiment, the flexible, elongated tube may be a silicone tube having a length of at least twenty feet long and operative for filtering or muffling noise component transmission of the air flow prior to entry into the socket member. In this manner, by means of the elongated flexible tube, noise signal components conveyed from the output port of the chamber are further reduced prior to entry into the socket member.

### BRIEF DESCRIPTION OF THE DRAWINGS

A more detailed understanding may be had from the following description, given by way of example in conjunction with the accompanying drawings, wherein:

FIG. 1 is a perspective view of an exemplary phonograph system with tone arm assembly and air compressor according to an embodiment of the disclosure;

FIG. 2A is an isometric view of an exemplary tone arm assembly for a phonograph according to an embodiment of the disclosure;

FIG. 2B is a schematic side view of the exemplary tone arm assembly of FIG. 2A;

FIG. 3 is a partial sectional view of components of the tone arm assembly shown in FIG. 2A according to an embodiment of the disclosure;

FIG. 4A is a side perspective of an exemplary tone arm assembly for a phonograph showing an exaggerated separation of the upper hemisphere from the lower socket member according to an embodiment of the disclosure;

FIG. 4B is a top view of the hemispherical air bearing structure shown in FIG. 4A;

FIG. 4C is a section view of the hemispherical air bearing structure shown in FIG. 4B along line B-B;

FIG. 5 is an exploded view of exemplary component subassemblies of the tone arm assembly according to an embodiment of the disclosure;

FIG. 6 is an exploded view of an exemplary queuing mechanism subassembly according to an embodiment of the disclosure;

FIG. 7A is an exploded view of an anti-skate adjustment mechanism subassembly according to an embodiment of the disclosure;

FIG. 7B is a view of the underside of the upper hemispherical bearing member along A-A of FIG. 7A;

FIG. 8 is an exploded view of an elevating and leveling mechanism subassembly according to an embodiment of the disclosure;

FIG. 9 is an exemplary illustration of component interconnections for the tension resonance rod, tone arm tube, and head shell of the tone arm assembly according to an embodiment of the disclosure;

FIG. 10 schematically illustrates a low pressure, low noise fluid pump including compressor and air chamber components according to an embodiment of the disclosure;

FIG. 11 is a more detailed illustration of the pump components of FIG. 10;

FIG. 12 schematically illustrates fluid flow between the fluid pump and tone arm assembly via an elongated conveyance tube according to an embodiment of the disclosure.

### DETAILED DESCRIPTION

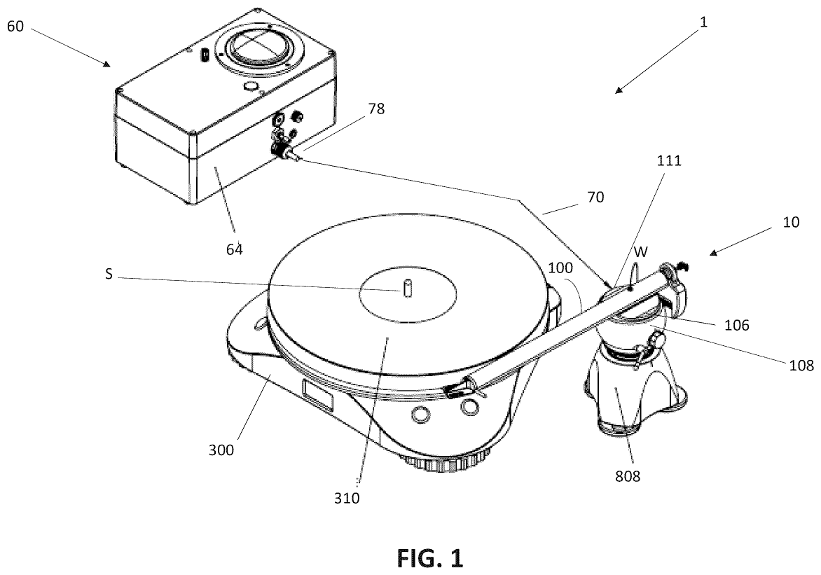

Referring now to the drawings in detail, wherein like elements are designated by like reference numerals, there is shown in FIG. 1 a phonograph system 1 comprising a mounting board or plinth 300 and turntable 310 for receiving a platter or record. A turntable spindle S passes through the center hole to secure a record. The aforementioned elements or members are used in conjunction with a tone arm system or assembly 10 with hemispherical air bearing comprising upper hemispherical member 106 and socket member 108 according to the present disclosure. A pump member 60 with compressor 64 is configured to communicate fluid (air) pressure from an outlet port 78 to an inlet 111 on the tone arm via an elongated conveyance tube 70 to supply low flow, low pressure fluid (air) to the hemispherical air bearing such that tone arm wand 100 floats or levitates on the thin film of air on all axes. The pump or air compressor may be positioned remote from the tone arm assembly (e.g. twenty-five feet away) and connected by means of a flexible conduit or tube 70 to bring the compressed air from the pump to the tone arm system.

In operation, the tone arm wand with hemispherical air bearing is positioned such that the cartridge may play vinyl records on the turntable. The spherical air bearing allows the cartridge and its stylus to track the groove in the record with little to no resistance, thereby enhancing the sound signature. Adjustment and compensation mechanisms associated with components of the tone arm system operate to ensure that the stylus on the cartridge is held in the precise orientation required to reproduce the sound accurately.

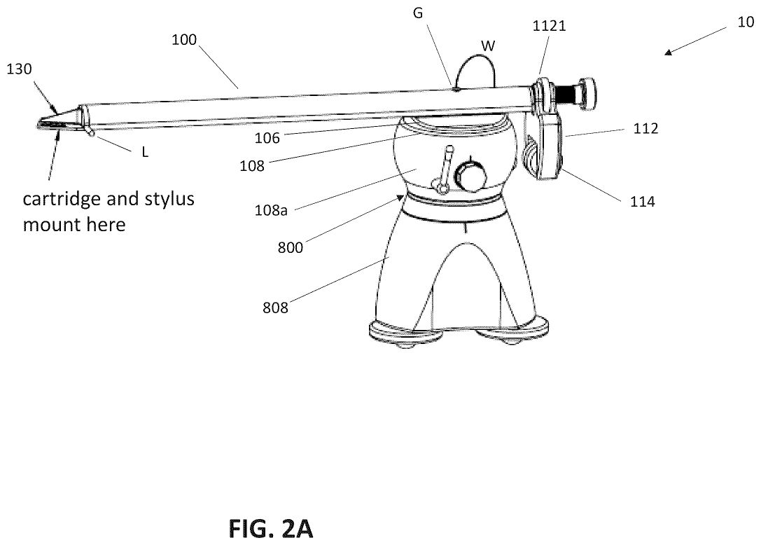

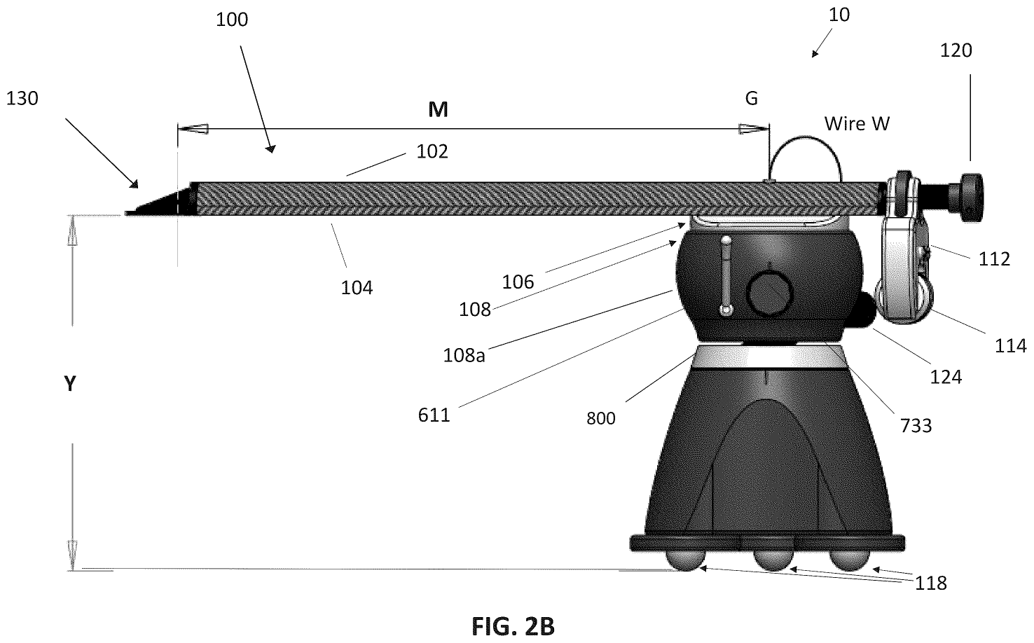

As is understood, various types and sizes of turntables may be used. The tone arm system or assembly of the present disclosure may then be arranged at an appropriate distance relative to the turntable, as is understood by one of ordinary skill in the art. FIG. 2B shows a tone arm assembly illustrating a measure M of the distance from the center of pivot to spindle. A measure Y of the distance from the top of the record platform to the underside of head shell 130 is also illustrated. A setting fixture (not shown) may be used for calibrating the appropriate distance from the center of pivot to the spindle. The setting fixture may be (temporarily) attached (e.g. bolted) to the top of socket 108 and engaging the spindle S on the turntable. After this one time use in setting the appropriate distance M, the setting fixture may be removed and the tone arm assembly with hemispherical air bearing placed in operation.

According to an aspect of the disclosure, a tone arm apparatus and system comprises a hemispherical air bearing in a pivotable tone arm operable on all axes so as to provide a virtually frictionless bearing operative on the tone arm, thereby enabling a stylus and cartridge that converts vibrations in the record groove to electrical signals, to transmit the signals without unwanted bearing noises impacting upon the sound quality of the transmission.

### Overview

It is to be understood that the goal of any tone arm is to not influence the stylus or playing of the record, but to allow or enable only the record signal to be heard (without noise components influencing the signal). The system according to the present disclosure enhances performance and overall signal quality output by including means for reducing undesired noise characteristics via a hemispherical air bearing in a pivoted tone arm, resulting in a configuration where no physical connection exists between the top half of the tone arm and the base of the tone arm, and where only an electrical wire makes a physical connection.

The system of the present disclosure includes one or more adjusting mechanisms for making adjustments as to one or more of resonance, anti-skate, azimuth, pneumatic bearing, and filtering of unwanted noise components in communicating the electrical signal (e.g. micro voltage signal range) from the cartridge downstream to the phonostage. It is understood that low micro voltage signals from the record may be influenced by minimal disturbances due to friction and/or other deleterious signal conditions. The tone arm system of the present disclosure implements component parts arranged and integrated in a novel configuration that includes a “D”-shaped cross section carbon fiber tone arm tube or arm wand 100 and a hemispherical air bearing member 106 and socket member 108 that supports the tone arm tube or wand on a thin film of air on all axes. A pump member 60 with compressor 64 and air chamber 66 is fluidly coupled to the socket member via elongated conveyance tube 70 to supply the low flow, low pressure fluid (air) for conveyance via the socket member and hemispherical air bearing such that wand 100 floats or levitates on the thin film of air on all axes.

### Tone Arm

As best shown in FIGS. 2A, 2B, 3, 4A-C, and 5, tone arm system 10 comprises a tone arm 100 configured as an elongated “D”-shaped carbon fiber tube or arm wand having a curved or arcuate upper surface 102 and a flat or planar lower surface 104. As shown in the drawings, carbon fiber tube 100 is substantially flat on the bottom and rounded on top in arcuate fashion to form the cross-section shape of a “D”. Tone arm 100 includes at its distal end a head shell 130. Head shell 130 attaches to and holds a cartridge and stylus (not shown) that picks up the groove in the record by means of the stylus, as understood by one of ordinary skill in the art. The cartridge and stylus assembly mounts to the underside of the head shell 130. The phonograph cartridge with stylus engages and radially tracks a groove in a phonograph record on the turntable. The cartridge converts the vibrations in the record groove to electrical signals which are then transmitted via carbon tone arm 100 through wire W and out sleeve 124 (FIG. 2B). Sleeve 124 provides for an electrical connector (e.g. electrical socket) that transmits the electrical signals that the record is transmitting. In an embodiment, the tube 100 houses the signal wire W, which exits through a grommet G (for example, a plastic grommet) as shown. The cabling of wires (e.g. 4 wire connection) having electrical connection means (e.g. wire plug connector(s)) to connect with the cartridge for conveying the record signal from the cartridge through sleeve 124 and to subsequent phonostage processing elements are provided within the fiber tube. Lifting lever L is coupled at the distal end of tube 100 and head shell 130 and operable to move the upper assembly to queue certain track or park the tone arm off of the record. Although tube 100 is shown as a cross-section D-shaped carbon fiber tube, the present disclosure is not limited thereto, and encompasses other types of composite materials and geometries, including but not limited to graphite or other crystalline forms embedded in a polymer matrix, as well as geometries which deviate from the D-shaped cross-section. The form or material of the tube may be one of the parameters to which the tone arm may be tuned for enhancing the performance of the tone arm system, as different constructions may alter the resonant frequency, damping, and the like. The resonance adjustment mechanisms disclosed herein operate to adapt the system to such variations.

### Hemispherical Air Bearing and Socket Member

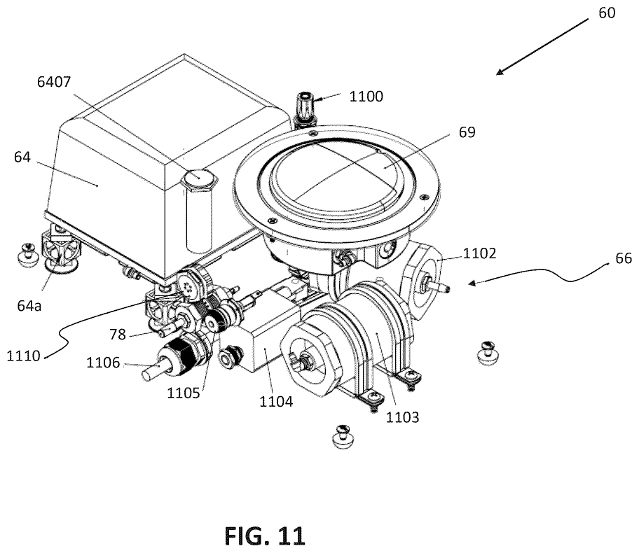

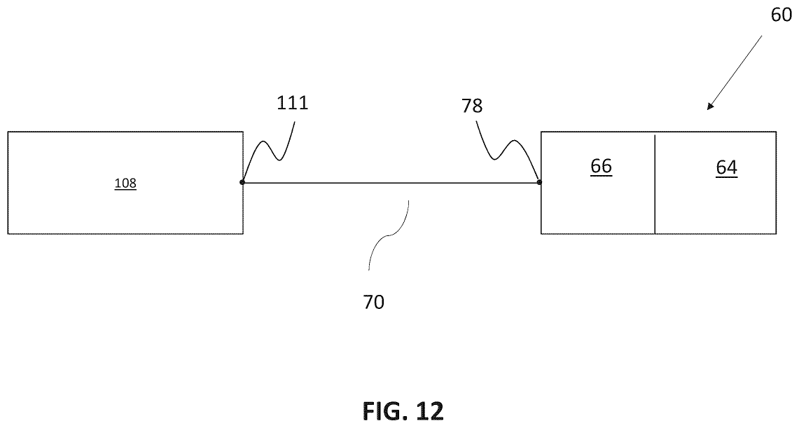

As best shown in in FIGS. 2A, 2B, 3, 4A-C, and 5, according to an embodiment of the disclosure, an upper hemispherical air bearing member 106 is coupled to the underside of tone arm 100 and represents the upper part or male portion of the hemispherical air bearing, which is configured to ride on a thin film of fluid (air) supplied from pump compressor 64 (see FIG. 11) coupled to socket 108 via conveyance tube 70 (see FIG. 12). Upper hemispherical member 106 operates with member 108 like a ball and socket bearing or ball and socket arm. However, according to the present disclosure, this air bearing configuration makes for a virtually frictionless bearing which enables the cartridge and its stylus to play a record with significantly less bearing noise propagating through the system.

The ball and socket equivalent represents the male or upper hemisphere member and the female socket member of the two mated elements, wherein an air gap is pressurized to a few inches of water (e.g. 4 inches minimum), so that the hemisphere 106/socket 108 form an air film there between to levitate or float the upper hemisphere at an extremely tight tolerance level. Such configuration provides a consistently applied air film gap, that the pump regulator operates to essentially instantaneously adjust, at a level of only a few inches of water/pressure.

In a preferred embodiment, upper hemisphere member 106 (and socket member 108) is formed of a metal such as aluminum. Other metals or hard coats, including but not limited to brass, stainless steel, bronze, or other sturdy, non-porous materials sufficient for high tolerance, durable, non-leak applications, are also contemplated.

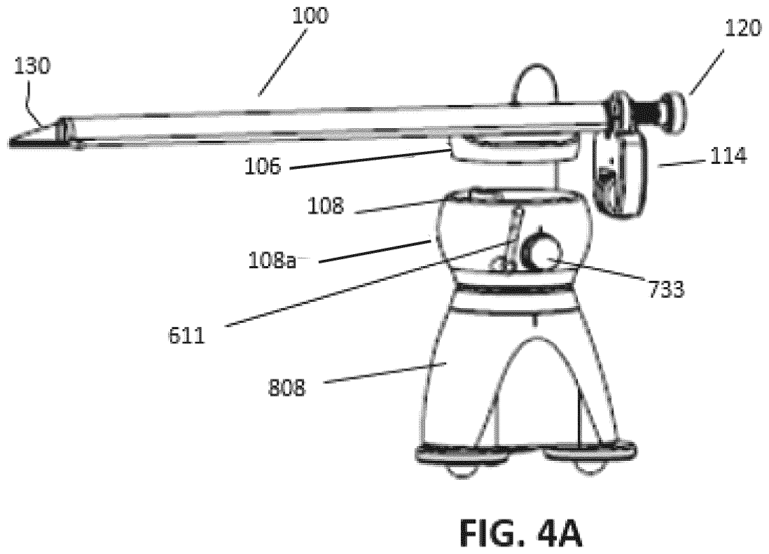

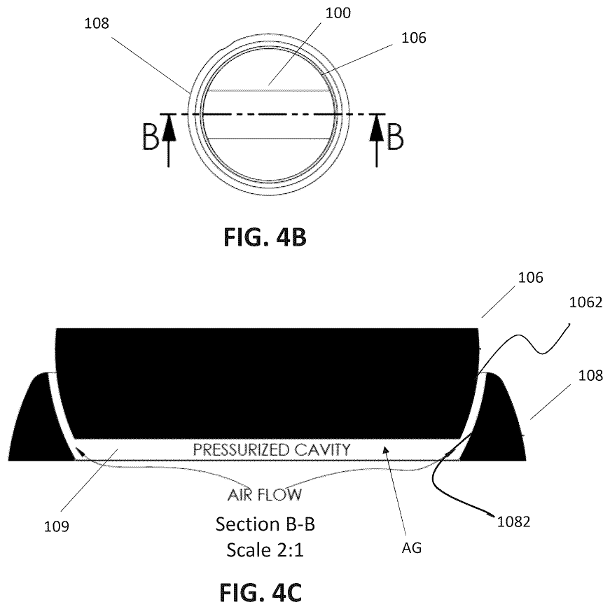

Referring to the embodiment illustrated in FIGS. 4A, 4B, and 4C, the bearing is spherical in shape on the male part of the hemisphere 106 which accurately matches the spherical shape in the female portion of the socket 108. The gap where the air flows is tightly controlled by the pressure adjustment on the air compressor 64 (FIG. 11). For high fidelity tone arm phonograph applications, the gap may be adjusted to maximize overall system fidelity. The pressure adjustment on the air compressor may influence the sound by being more sharp or soft depending on the listener's preference for the type of music being played. This air gap eliminates the touching of the two metal hemispherical members and provides a nearly frictionless bearing surface which greatly enhances the sound signature of the tone arm system. The cavity is configured to evenly feed the air into the air gap so that the system is stable and self-regulating.

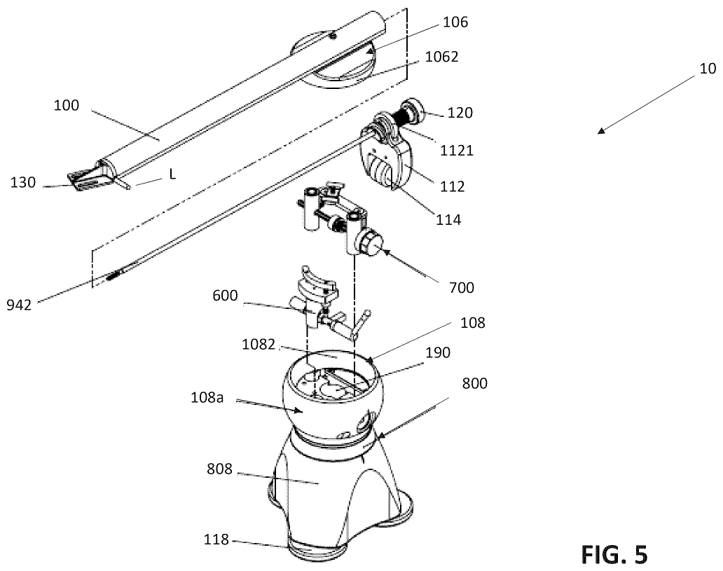

As best shown in FIG. 5, socket member 108 represents the lower half of the hemispherical air bearing whose body portion 108a holds various components therein, including: queuing mechanism 600, magnetic anti skate mechanism 700, and elevating and leveling mechanism 800, along with electrical connection 124 and fluid (air) connection/cavity 109 (FIG. 4C). Adjustable leveling feet 118 are provided on the bottom of base 808 to level the entire assembly.

Upper hemispherical air bearing member 106 and socket member 108 form the ball and socket arm that enables the tone arm wand 100 to ride on the thin film of air on all axes. As best shown in FIG. 4C, upper hemispherical bearing member 106 is configured as a curve or a segment of a curved outer surface 1062 that follows the inner socket wall 1082. That is, upper hemisphere bearing member 106 is representative of a segment of a ball in the ball and socket arrangement, wherein the interface is configured as a spherical curve. The upper hemisphere bearing member illustrates a transition from the top to the sidewall as a fillet, which represents a smooth contoured surface. The air gap AG or thin film is applied between member 106 and the socket side 108. In accordance with an aspect of the disclosure, the interior of the socket is pressurized, with air flow communicating upward against the hemisphere 106 or top assembly. In operation, as air flows or leaks out from the interface between the hemisphere curvature and socket curvature, as best shown in FIG. 4C, the thin film of air levitates the upper hemisphere bearing member 106 and hence, arm wand 100, which thereby rides on the frictionless air gap AG within pressurized cavity 109.

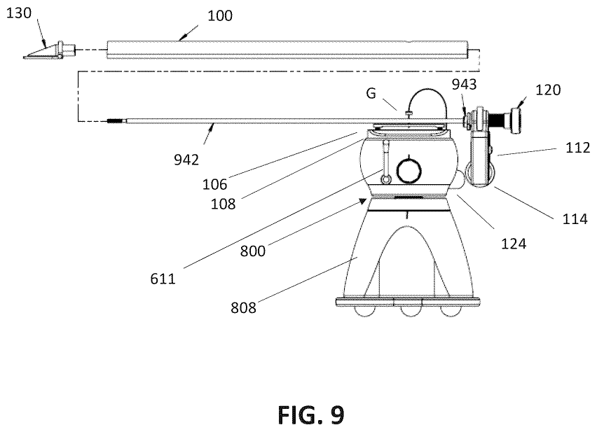

In accordance with a further aspect of the disclosure, member 106 represents the entire working area with the side wall of the component being the only interface to the socket. Accordingly, the bearing wall of upper hemispheric member 106 interface with socket 108 enables member 106 to ride on the thin film of air to enable virtually frictionless bearing which enables the cartridge and its stylus to play the record with significant reduction in deleterious bearing noise. In this manner, the system of the present disclosure provides for superior signal preservation to a contact bearing. The present disclosure additionally provides superior performance over tangential tone arm structures, wherein the film of air works across a tube to move laterally and up/down. Such prior art devices are not only unwieldy, weighty and unduly sensitive to external factors, such as unable to fit a range of turntables, but also employ physical bearings that necessarily comprise greater frictional components. Unlike prior art devices, the tone arm system of the present disclosure provides a pivoted hemispherical air bearing arrangement operative as a unipivot tone arm that uses an air bearing in all axes and without a physical bearing contact. Moreover, the pivoting tone arm system of the present disclosure is configured to drop into existing turntable designs with minimal alterations. Further still, as best shown in FIG. 2A and FIG. 9, the tone arm assembly provides a compact design that eliminates protruding appendages commonly found in prior art designs, enhancing functional efficiency by reducing bulk, minimizing potential interference, and simplifying integration into various settings.

As illustrated in FIG. 5, in accordance with a further aspect of the present disclosure, tone arm wand 100 is coupled to upper hemispherical member 106, for example, via one or more screws from the underside of the structure. In an exemplary embodiment, the structure includes a cavity under the hemisphere having screws engaging with a plate inside the cross-section D-shaped tube, thereby drawing it down in a clamping arrangement. Such arrangement provides sufficient rigidity and resonance while obscuring and protecting any hardware connections and visual perception from above Furthermore, in view of the magnets used to provide anti skate forces as part of the anti-skate mechanism 700, the system of the present disclosure utilizes non-magnetic materials for other components so as to avoid unwanted distortions from other magnetic materials and thereby ensure greater system predictability, accuracy, and reliability.

Referring to FIG. 5, there is shown an exploded view of various component parts of the tone arm system of the present disclosure, including an interior portion of socket member 108 illustrating various components of the tone arm system for effectively making adjustments to one or more of resonance, anti-skate, azimuth, pneumatic bearing, and filtering of unwanted noise components. As previously discussed, socket member 108 is the lower half of the hemispherical bearing arrangement and contains other component elements including: queuing mechanism 600, magnetic anti skate mechanism 700, electrical connection, air connection and an elevating and leveling mechanism 800. Each of these components is housed within the compact enclosure and designed to enhance functional efficiency by reducing bulk, minimizing potential interference, and simplifying integration into various settings.

### Anti-Skate

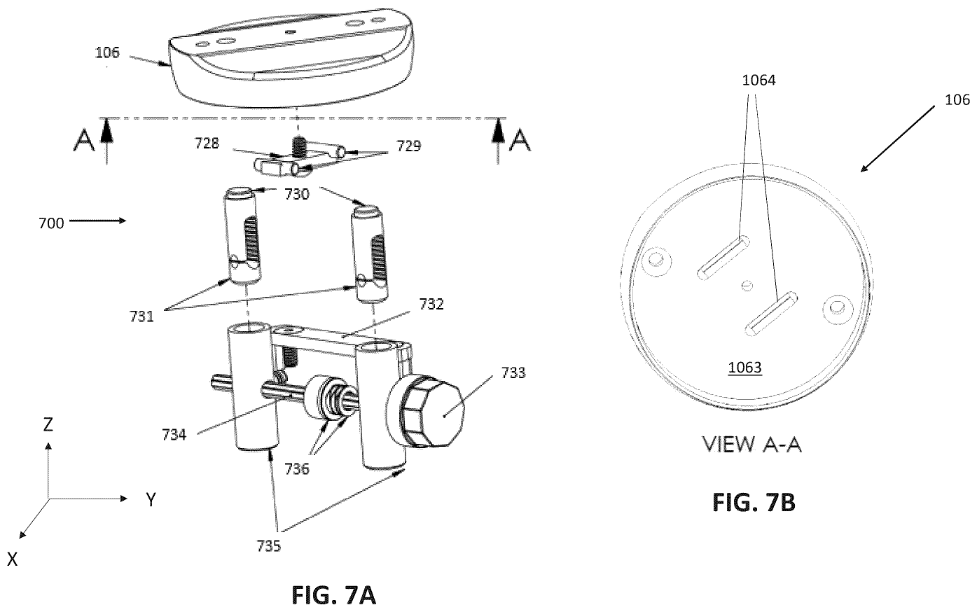

Anti-skate mechanism 700 is included in the socket member adjacent the tone arm pivot for balancing out the skating force, which is the result of the arm geometry coupled with the friction of the stylus in the groove. This adjustment enables the stylus to be seated and centered within the record groove, ensuring accurate tracking and minimizing distortion. As best shown in FIG. 5 and FIG. 7A, the anti-skate mechanism includes magnets 730 which telescope vertically to interact with other magnets 729 in the hemisphere there above, which counteract the skating force, and provide a more precise and adjustable anti-skate control. A controller is operative to adjust the anti-skate mechanism inside of the socket. In one embodiment, the controller is implemented as an adjustable knob 733 on the outer surface of socket member 108 and having a plurality of different settings thereon used to adjust the anti-skate mechanism inside of the socket. Adjusting the knob setting adjusts the magnet assembly inside, which corrects the tangential pulling force that is encountered when playing a record. This force needs to be countered in order to keep the stylus playing both sides of the two channels that are in the groove of the record in a balanced manner.

By way of further explanation, as vinyl records are played with a rotating tone arm, a radial force is generated which can bias and/or hold the stylus to one side of the groove in the record. In doing so, the stylus can favor one side of the groove and play one of the stereo channels louder than the other. This imbalance may be overcome with an anti-skate adjustment according to the present disclosure. The anti-skate adjustment employed in the tone arm system according to an aspect of the present disclosure is implemented by means of magnets two sets of magnets 729, 730. Such implementation is advantageous because the magnetic force is not a mechanical interference with the floating upper hemisphere member 106, yet it counteracts the skating force induced in this design. Further, this force can be adjusted while the record is being played, which enables the listener with the ability to tune it more accurately. Two sets of magnets are used in the implementation shown in FIG. 7A. As shown, one set 729 is illustrated as horizontal magnets 729, and a second set of vertical magnets 730. The horizontal magnets are oriented parallel to each other along a horizontal plane (e.g., the XY-plane). The horizontal magnets are attached (e.g. clamped) to the underside of the upper hemisphere member 106 by means of horizontal magnet clamping plate 728. As shown in FIG. 7B, upper hemisphere member 106 includes cavities or depressions 1064 formed on the underside 1063 for receiving magnets 729. Referring again to FIG. 7A, the vertical magnets are oriented parallel to each other along the Z-axis. The vertical magnets 730 are held in vertical magnet carriers 731. These vertical magnet carriers 731 have a rack with guide sleeves 735 for receiving the magnet carriers and a horizontal hold down bracket 732. The rack with vertical magnets engages a pinion 734 to allow for an adjustment using adjusting knob 733. Raising and lowering the vertical magnets 730 inside the vertical magnet carriers 731 causes a change in the magnetic forces acting on the horizontal magnets 729, which in turn changes the rotational force on upper hemisphere member 106. This rotational force counteracts the skating forces induced when playing a vinyl record. A tensioning spring and collar 736 is positioned about pinion 734 to cause a drag on the adjustment which holds the adjustment in place.

### Queuing Mechanism

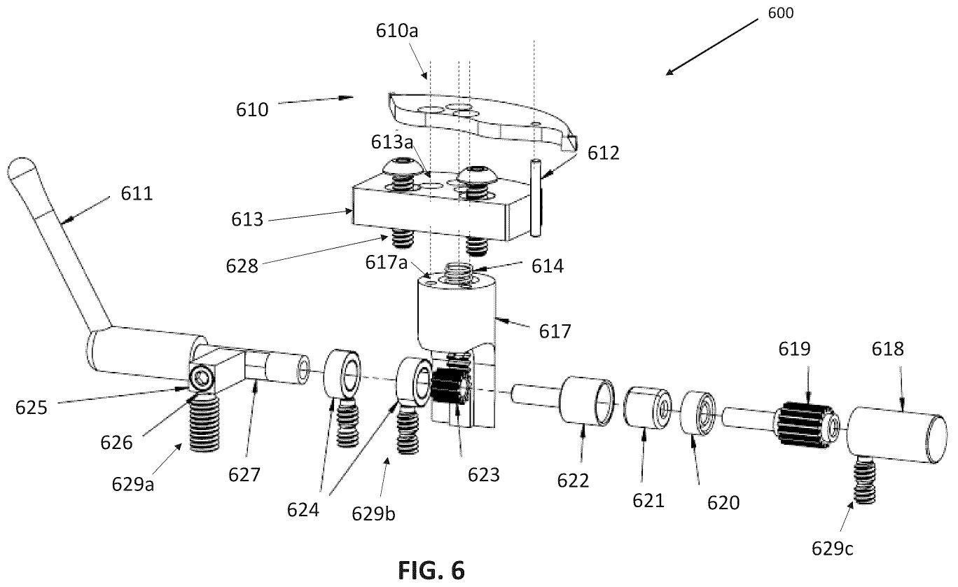

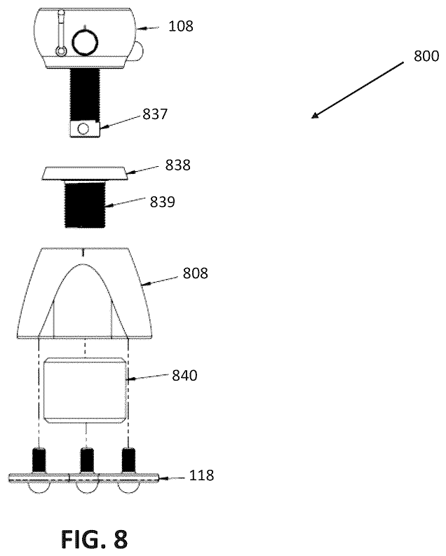

As best shown in FIGS. 5 and 6, queuing mechanism 600 is responsible for raising and lowering the tone arm onto the record surface and for the protection of the stylus and the convenience of the user. The queuing mechanism includes one or more lifting pads that the queuing mechanism uses to lift the tone arm off of and onto the record. A cap that is part of the queuing mechanism is configured to protect elemental interaction of components below the cap. A queuing lever is operative as a manual mechanism for lifting and lowering the cartridge's stylus in a slow, controlled, and uniform fashion onto the record surface. In an embodiment, engagement of the lever activates the queuing mechanism. In an embodiment, upon completion of record play, the lever is rotated clockwise ninety (90) degrees to raise the cartridge off of the record, so that the cross-section D-shaped tone arm may be moved out of the way (e.g. out of vertical alignment) so that the record may be removed. The queuing mechanism may be held by means of a magnet when its lever is in the vertical position. This is the position that is off of the record and needs to be held away when a record is being changed. An elevating device (see e.g. FIG. 8) is also provided for changing the height of the cross-section D-shaped tone arm to be level to accommodate records that vary in thickness.

By way of further explanation, as is to be understood, the stylus on the cartridge is to be lowered or queued, very gently, onto the record. With reference to FIGS. 5 and 6, due to its relative proximity to the center of rotation on upper hemisphere member 106, the queuing mechanism 600 downward travel is rather small relative to the arm that is holding the cartridge positioned a given distance (e.g. several inches) away from the center of rotation of hemisphere member 106. The travel of the queuing handle 611 is set at ninety degrees (90°). Lifting rack 617 operates to reduce this travel. Lifting plate 610 pushes upward against the bottom surface of upper hemisphere member 106, which then raises the cartridge off of and lowers onto the record. Lifting plate 610 is further guided by means of guide pin 612 extending through a top surface of cap 613 to prevent rotation. Fasteners (not shown) are inserted via one or more through holes 610a, 613a, and 617a located on lifting plate 610, cap 613 and rack 617, respectively, to fasten together the lifting plate 610 to cap 613 and rack 617. Cap 613 may be fastened to the socket member (not shown) by means of fasteners 628 in the form of two button head screws, by way of non-limiting example.

In order to provide a downward force, rack 617 and pinion 623 drive is employed with a spring 614 to translate the downward force to a rotational movement. Damping rotor 619 controls the speed or dampening of the movement. Rotor 619 rotates inside rotor sleeve 618, filled with a viscous fluid (e.g. grease). The assembly inside rotor sleeve 618 is sealed by shaft seal 620 to prevent fluid leakage. In operation, a user returns the mechanism to a parked position by directing queuing handle 611 to a vertical position and thereby actuate queuing shaft 627. Magnet 626 and magnet stick 625 secure it in place. When the record is queued, rack 617 operates to stop queuing handle 611 ninety degrees relative to the horizontal position. The shaft assembly is mounted inside a pair of bearings 624. Screw sets 629a, 629b, and 629c, operate to hold in place queuing shaft 627, bearings 624, and rotor sleeve 618, respectively. Damping rotor 619 is driven through a one way clutch 621 with clutch carrier 622. The one way clutch 621 drives the damping rotor 619 in one direction only and provides for an easier return of the mechanism as it disengages the damping rotor 619.

### Azimuth Adjust

Referring now to FIGS. 2B, 5, and 9, the tone arm system includes an azimuth adjustment mechanism 114 comprising an azimuth weight that allows fine-tuning of the azimuth angle of the tone arm. This adjustment cants the assembly to enable the stylus to be set at the correct angle to play the record accurately. A balance weight 112 counterbalances the assembly. This weight along with the threaded spindle there above enables a fine adjustment to achieve an accurate balance.

By way of further example, the cartridge and stylus, which are mounted to head shell 130, require an adjustable down force to track the record reliably. This down force may be set by the balance weight 112 attached toward a proximal end of tone arm wand 100. This weight may be adjusted along a threaded cylinder by means of balance weight adjustment knob 1121. The canted angle of the stylus (azimuth) is adjusted by azimuth adjustment member 114. As the weight is moved along the thread, the tone arm tilts, adjusting the azimuth angle of the stylus.

### Elevation Adjust

As best shown in FIG. 2B in conjunction with FIG. 8, the tone arm system according to an embodiment further includes a leveling adjustment 800 with a plurality of (e.g. three) leveling feet 118 which are evenly spaced at the bottom of the base portion 808 of the tone arm assembly 10. In addition, the socket member 108 which carries the spherical bearing and cartridge that plays the record can be raised and lowered to maintain a horizontal position for the D tube 100. As is understood, vinyl records can vary in thickness. An adjustable elevating nut 838 with locking collar 839 is provided for engagement with threaded post 837. Rotation of elevating nut 838 causes the entire assembly to be raised or lowered by an appropriate amount to accommodate for variation in thickness. The locking collar 839 is inserted into base 808 and secured by means of iron nut 840.

### Resonance Adjust

As best shown in FIG. 2B in conjunction with FIG. 9, tone arm 100 further includes a rotatable knob 120 and threaded spindle for adjusting the resonance of the upper tone arm assembly. This keeps the upper assembly from negatively vibrating the playing of the record. The adjustable knob enables changing the tension on the tube 100, which in turn changes the resonance of the tube. This resonance control mechanism of the present disclosure is configured to enable the user to effectively tune the upper tone arm assembly and adjust the resonance to optimally align with the specific characteristics of the record being played or listened to.

More particularly, FIG. 9 shows an exploded view of the tone arm assembly 10 configured not only to properly hold the cartridge and its stylus, but to resonate such that it does not influence the vibrating stylus that is reading the groove in the record. The cross-section carbon fiber D-shaped tube 100 is clamped between the head shell 130 and the tension rod plug 943. This adjustment is spring loaded so that as the tension adjustment 120 is rotated, the resonance of the cross-section D-shaped tube 100 is changed, thereby affecting the quality of the sound. The compact design of the present disclosure eliminates protruding appendages commonly found in prior art designs, enhancing functional efficiency by reducing bulk, minimizing potential interference, and simplifying integration into various settings.

### Socket Member Air Pressure Cavity

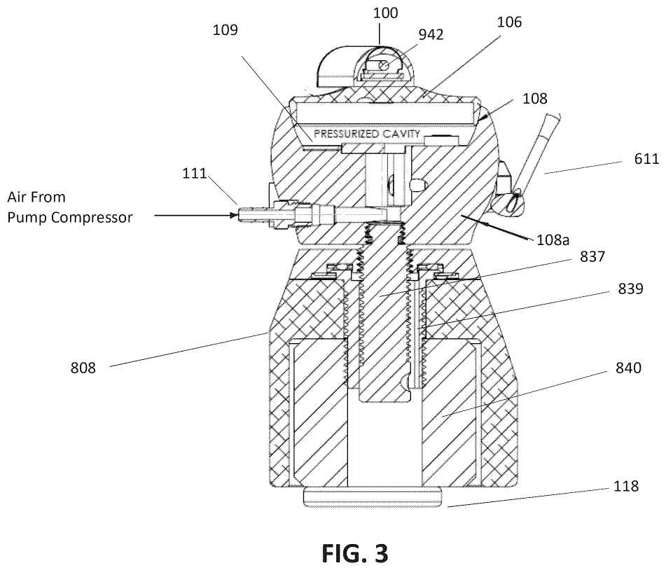

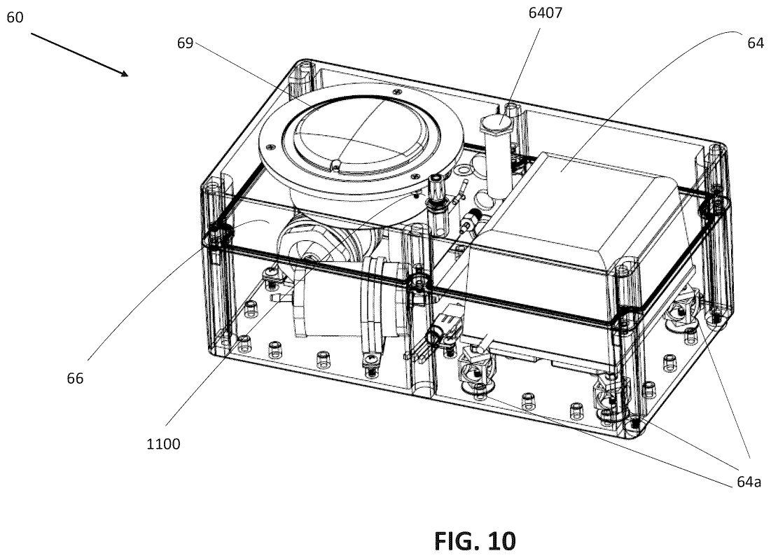

Referring now to FIG. 3 in conjunction with FIGS. 4A-4C, socket member 108 has defined therein a centrally located cavity 109 that communicates the air pressure from the bottom central portion of the socket inlet port 111 to the upper hemispherical member 106. Socket member 108 includes inlet port or fitting 111 illustrated schematically in FIG. 3, for receiving the input air pressure. In an embodiment, relative aperture size is 3/16 inch (inner diameter or “inlet”). In an exemplary embodiment, the inlet port may comprise a barbed air fitting, which may be slid about an elongated conveyance tube 70 (FIG. 12) which connects the inlet 111 of socket member 108 with the outlet port 78 of pump chamber 66 (see schematically FIG. 8). The cavity 109 and inlet port 111 are fluidly coupled such that the air pressure from compressor pump 64 (FIG. 10) is conveyed radially into the center of the socket and pressurizes the socket. The air in the socket member 108 flows towards the center of the socket member and turns vertically upward in the portion of the cavity under upper hemisphere member 106. This pressurizes the cavity below the hemisphere member, which causes the upper half hemisphere member and tone arm to float on this bubble of air. In this manner, the elongated conveyance tube 70 supplies the low flow, low pressure fluid (air) from the pump for conveyance to the hemispherical air bearing tone arm, thereby enabling the wand 100 to float or levitate on the thin film of air on all axes without any physical bearing support. The air passage cavity is designed to gradually increase in volume from the point of entry to its exit at the hemisphere. This configuration effectively reduces noise generated by rushing air and provides a muffling effect, minimizing interference with the audio system.

### Pump Configuration

FIGS. 10-11 are representative embodiments illustrating aspects of the fluid pump or compressor in communication with the tone arm system for a turntable, for communicating fluid pressure thereto according to an embodiment of the disclosure. As shown therein, the tone arm system requires a very clean, pulsation-free compressed air source having a tightly controlled pressure and flow. An elongated conveyance tube 70 (FIG. 12) connects the air outlet 78 of the air pump compressor 64 to the tone arm assembly 10. A barbed fitting disposed on the back side of the air pump connects the flexible tube for transmitting the fluid (air) to the tone arm system. Conveyance tube 70 may comprise a flexible tube that connects the air outlet of the compressor to the inlet 111 of the tone arm assembly for connecting these components to float the hemispherical bearing between the socket and the hemisphere.

Referring still to FIGS. 10-11 there is illustrated the pump housing containing the components of the air supply compressor. Pressure gauge 69 operates to monitor the pressure output of the compressor. Control 1100 may be configured as an adjustable selector knob used to change the air pressure. Pump 60 further includes a power switch 6407 for powering the device. Power may be supplied via a 120 VAC power source, as is understood by one of ordinary skill.

Vibration isolators 64a are positioned on the feet of the compressor to reduce vibrations that deleteriously affect generation of the pressure signal. Air chamber 66 or muffling chamber is communicatively coupled to compressor 64. Additional components within the housing include construction items including wiring, electrical plug, inlet filter, outlet plumbing, connection tubing, and the like.

Unlike conventional piston-operated air pumps that produce loud and noisy outputs, the present disclosure introduces a quieter pump designed for low flow and low pressure operation. Pump 60 is mounted on vibration-isolating absorbers within a sealed housing enclosure, which includes isolation feet to further dampen vibrations. A sealed chamber, in downstream fluid communication with the pump compressor, is incorporated to reduce pulse noise before the air exits the pump chamber and is conveyed to the socket member. Additionally, the combination of vibration isolators, the enclosed housing, and dimmer circuitry offers two key benefits:
(1) Noise reduction: The system significantly reduces the audible output of the pump, which is important in audio applications to preserve sound quality.
(2) Vibration mitigation: By minimizing vibrations transferred from the pump to the floor, the design prevents these vibrations from propagating into the cartridge, thereby maintaining high audio fidelity.

In an embodiment, chamber 66 is open with an inlet (compressor side) and an outlet (socket side) and sealed otherwise. When the air pressure from the pump compressor is output to the chamber 66, a certain pulsing frequency is applied or output from the pump. Those pulses are expanded in the muffling chamber and dissipated at the chamber outlet. In an embodiment, the air chamber comprises a polymeric material (plastic) housing.

More particularly, a pulsing sound transmits out of the nozzle that is blown into the chamber 66. The pulsing shock waves impact the internal walls of the chamber but they do not find their way to the outlet hole(s) on the other side of the chamber. Instead, they are dissipated by impinging the walls of the chamber, which may be embodied as a sealed plastic container. Because the shock waves are expanding from the inlet side, they are dispersed over the whole area inside the chamber such that virtually none of it finds its way to the outlet. The plastic (e.g. polyethylene) chamber housing successfully eliminates substantially all of the noise frequencies at its output port 78.

More particularly, air compressor 64 represents the first stage in the supply of compressed air. This compressor provides an oscillating force whereby a pulsing air supply is generated. This generated pulsed supply requires further processing to be usable by the tone arm system. The vibrations of the air compressor 64 are reduced by four wire rope vibration isolators 64a on which the air compressor 64 is mounted. Air inlet 1110 (FIG. 11) receives the pulsed air which is compressed by the air compressor 64. The air is then conveyed to a first dampening tank 1103. The outlet of the first dampening tank 1103 is then piped to the second dampening tank 1102. As the air passes through these two tanks, the pulsing is reduced to an acceptable level. The outlet of the second dampening tank 1102 is then piped to the pressure adjustment member 1100. In one embodiment, pressure adjustment member 1100 may be a user-adjustable pinch valve for controlling tone arm float. Pressure gauge 69 provides an indication of current pressure. Typically, the system may be configured to run at about a minimum of four inches of water. This value may vary depending on one or more system conditions, such as the weight of the cartridge installed on the head shell 130. The air then exits through air outlet 78 into a flexible tube that is then connected to the tone arm. The unit is plugged into a standard 120 VAC outlet by means of power cord and protected from power overload by means of fuse 1105. In order to compensate for or reduce the oscillating of the air compressor 64, pump amplitude control or dimming circuit 1104 is provided to electrically trim or minimize the oscillating of the air compressor 64. This adjustment may be factory-set or may be made user-accessible for modification in the field. Power switch 6407 (FIG. 10) mounted on the top of the unit enables turning on and off of air compressor 64.

In an embodiment, tube 70 is configured to be upwards of 20 feet long. The length of flexible tubing operates to assist in further filtering or muffling the transmission down the tube prior to entry into socket member 108. That is, by means of the elongated flexible tube, any additional noise components entered into the socket are diminished for reducing detection by sensing components, with the goal of eliminating all of the noise in the speakers except what the record is playing.

Thus, there is disclosed a tone arm system (10) for engaging a record on a turntable, comprising: a pivotable tone arm (100) operable on all axes, and a hemispherical air bearing coupled to the pivotable tone arm and comprising an upper hemispherical bearing member (106) and a socket member (108), wherein the upper hemispherical bearing member is configured to ride on a thin film of air within the socket member to provide a virtually frictionless bearing that allows the tone arm to move on all axes, thereby enabling a stylus and cartridge coupled to the tone arm that converts vibrations in a record groove to electrical signals, to transmit the signals without unwanted bearing noises impacting upon the sound quality of the transmission.

In an embodiment, the upper hemispherical member (106) comprises an outer curved surface (1062) and the socket member (108) comprises an inner curved surface (1082) geometrically matched with the outer surface of the upper hemispherical member in a ball and socket configuration. In an embodiment, the socket member includes a cavity (109) for conveying a regulated fluid pressure for providing an air film interface between the upper hemispherical member outer surface and the socket member inner surface. In an embodiment, the upper hemispherical member (106) is coupled to an underside of the tone arm.

In an embodiment, the tone arm comprises a cross-section D-shaped carbon fiber tube.

In an embodiment, the interface is configured as a spherical curve.

In an embodiment, air flows out from the interface between the hemisphere curvature and socket curvature, whereby the thin film of air levitates the upper hemisphere bearing member and tone arm.

In an embodiment, the system further comprises an anti-skate mechanism for controlling rotational force on the tone arm, comprising: a first set of magnets (729) attached to an underside of the upper hemisphere member (106), the first set of magnets being arranged parallel to each other along a first plane; and a second set of magnets (730) arranged parallel to each other and oriented perpendicularly to the first set of magnets along a second plane. One or more carriers (731) hold the second set of magnets in a movable configuration. The system further comprises a rack with guide sleeves (735) for receiving and guiding the carriers of the second set of magnets, and an adjustment mechanism (733) operatively connected to the one or more carriers for raising and lowering the second set of magnets relative to the first set of magnets, wherein adjustment of the second set of magnets relative to the first set alters the magnetic interaction between the first and second sets of magnets, thereby controllably adjusting the rotational force applied to the upper hemisphere member to counteract an external skating force normally encountered when playing a record.

In an embodiment, the system further comprises a head shell (130) coupled to an end of the tone arm for mounting a cartridge and stylus, and a balance weight (112) attached to the tone arm, the balance weight being adjustable along a threaded spindle to regulate downforce on the stylus for accurate tracking of a record. A balance weight adjustment mechanism (1121) is configured to move the balance weight along the threaded spindle for fine-tuning the downforce. An azimuth adjustment mechanism comprises an azimuth weight (114), the azimuth weight being configured to adjust the azimuth angle of the tone arm to ensure proper alignment of the stylus, wherein movement of the balance weight along the threaded spindle adjusts the downforce on the stylus and the tilt of the tone arm to set the azimuth angle.

In an embodiment, the system further comprises a tension resonance rod (942) contained within tube (100). A rotatable adjustment knob (120) may be disposed on the tube and operatively connected to a threaded spindle for adjusting the tension in the tone arm. A tension rod plug (943) may be positioned to clamp the tone arm between the head shell and the tension rod plug. A spring-loaded mechanism may be operatively coupled to the adjustment knob, enabling variable tension in the tone arm, wherein rotation of the adjustment knob (120) alters the tension in the tone arm, thereby adjusting the resonance of the tone arm to reduce unwanted vibrations during playback and enable a user to tune the resonance to optimize sound quality.

In an embodiment, a phonograph system (1) comprises: a turntable (310) for receiving a record; a tone arm assembly (10) operatively associated with the turntable, the tone arm assembly including a tone arm (100) and a hemispherical air bearing structure (106/108); and a pump member (60) comprising an air compressor (64), the pump member configured to supply low-flow, low-pressure air via a conveyance tube (70) to the hemispherical air bearing. The air supplied to the hemispherical air bearing enables the tone arm to levitate on a thin film of air across multiple axes, enabling a cartridge and stylus attached to an end of the tone arm to track the groove of the record with minimal resistance, thereby enhancing sound quality by reproducing the record's impressions in a transmission of vibrations to the audio system. In an embodiment, the pump member includes a muffling chamber (66) for reducing pulse noise from the air compressor before the air is delivered to the tone arm assembly.

In an embodiment, the muffling chamber (66) comprises a polymeric housing that dissipates pulsing shock waves from the air compressor (64) by directing them against internal walls of the chamber, thereby reducing noise at an outlet (78) of the chamber.

In an embodiment, the muffling chamber (66) comprises a first dampening tank (1103) and a second dampening tank (1102) in fluid communication, the first and second tanks operable to reduce the pulsing of the air supply before reaching the tone arm assembly (10).

In an embodiment, the pump member further comprises a pressure adjustment member (1100) operable to control the air pressure downstream of the first and second dampening tanks and prior to being conveyed to the tone arm assembly for adjusting the levitation height of the tone arm (100).

Although features and elements are described above in particular combinations, each feature or element can be used alone or in any combination with or without the other features and elements. Accordingly, the present invention may be embodied in other specific forms without departing from its spirit or essential attributes.

The invention claimed is:

1. A tone arm system for engaging a record on a turntable, comprising:
a pivotable tone arm operable on all axes;
a hemispherical air bearing coupled to the pivotable tone arm and comprising an upper hemispherical bearing member and a socket member, wherein the upper hemispherical bearing member is configured to ride on a thin film of air within the socket member to provide a virtually frictionless bearing that allows the tone arm to move on all axes, thereby enabling a stylus and cartridge coupled to the tone arm that converts vibrations in a record groove to electrical signals, to transmit said signals without unwanted bearing noises impacting upon the sound quality of the transmission.

2. The system of claim 1, wherein:
said upper hemispherical member comprises an outer surface; and
said socket member comprises an inner surface geometrically matched with said outer surface of the upper hemispherical member in a ball and socket configuration;
wherein said socket member includes a cavity for conveying a regulated fluid pressure for providing an air film interface between the upper hemispherical member outer surface and said socket member inner surface, wherein said upper hemispherical member is coupled to an underside of the tone arm.

3. The system of claim 1, wherein the tone arm comprises a cross-section D-shaped carbon fiber tube.

4. The system of claim 2, wherein the interface is configured as a spherical curve.

5. The system of claim 4, wherein air flows out from the interface between the hemisphere curvature and socket curvature, whereby the thin film of air levitates the upper hemisphere bearing member and tone arm.

6. The system of claim 5, further comprising an anti-skate mechanism for controlling rotational force on said tone arm, comprising:
a first set of magnets attached to an underside of the upper hemisphere member, the first set of magnets being arranged parallel to each other along a first plane;
a second set of magnets arranged parallel to each other and oriented perpendicularly to the first set of magnets along a second plane;
one or more carriers for holding the second set of magnets in a movable configuration;
a rack with guide sleeves for receiving and guiding the carriers of the second set of magnets;
an adjustment mechanism operatively connected to the one or more carriers for raising and lowering the second set of magnets relative to the first set of magnets;
wherein adjustment of the second set of magnets relative to the first set alters the magnetic interaction between the first and second sets of magnets, thereby controllably adjusting the rotational force applied to the upper hemisphere member to counteract an external skating force normally encountered when playing a record.

7. The system of claim 2, further comprising:
a head shell coupled to an end of the tone arm for mounting a cartridge and stylus;
a balance weight attached to the tone arm, the balance weight being adjustable along a threaded spindle to regulate downforce on the stylus for accurate tracking of a record;
a balance weight adjustment mechanism configured to move the balance weight along the threaded spindle for fine-tuning the downforce;
an azimuth adjustment mechanism comprising an azimuth weight, the azimuth weight being configured to adjust the azimuth angle of the tone arm to ensure proper alignment of the stylus;
wherein movement of the balance weight along the threaded spindle adjusts the downforce on the stylus and the tilt of the tone arm to set the azimuth angle.

8. The system of claim 7, further comprising:
the pivotable tone arm comprising a cross-section D-shaped carbon fiber tube;
a tension resonance rod contained within the tube;
a rotatable adjustment knob disposed on the tube and operatively connected to a threaded spindle for adjusting the tension in the tone arm;
a tension rod plug positioned to clamp the tone arm between the head shell and the tension rod plug;
a spring-loaded mechanism operatively coupled to the adjustment knob, enabling variable tension in the tone arm;
wherein rotation of the adjustment knob alters the tension in the tone arm, thereby adjusting the resonance of the tone arm to reduce unwanted vibrations during playback and enable a user to tune the resonance to optimize sound quality.

9. A phonograph system comprising:
a turntable for receiving a record;
a tone arm assembly operatively associated with the turntable, the tone arm assembly including a tone arm and a hemispherical air bearing;
a pump member comprising an air compressor, the pump member configured to supply low-flow, low-pressure air via a conveyance tube to the hemispherical air bearing;
wherein the air supplied to the hemispherical air bearing allows the tone arm to levitate on a thin film of air across multiple axes, enabling a cartridge and stylus attached to an end of the tone arm to track the groove of the record with minimal resistance, thereby enhancing sound quality by reproducing the record's impressions in a transmission of vibrations to the audio system; and
wherein the pump member includes a muffling chamber for reducing pulse noise from the air compressor before the air is delivered to the tone arm assembly.

10. The phonograph system of claim 9, wherein the muffling chamber comprises a polymeric housing that dissipates pulsing shock waves from the air compressor by directing them against internal walls of the chamber, thereby reducing noise at an outlet of said chamber.

11. The phonograph system of claim 9, wherein the muffling chamber comprises a first dampening tank and a second dampening tank in fluid communication, the first and second tanks operable to reduce the pulsing of the air supply before reaching the tone arm assembly.

12. The phonograph system of claim 11, wherein said pump member further comprises a pressure adjustment member operable to control the air pressure downstream of said first and second dampening tanks and prior to being conveyed to said tone arm assembly for adjusting the levitation height of the tone arm.

13. The phonograph system of claim 9, wherein the hemispherical air bearing comprises:
an upper hemispherical member having a curved outer surface; and
a socket member having a curved inner surface geometrically matched with the outer surface of the upper hemispherical member in a ball and socket configuration;
wherein the socket member includes a cavity for conveying a regulated fluid pressure for providing an air film interface between the upper hemispherical member outer surface and said socket member inner surface, wherein the upper hemispherical member is coupled to an underside of the tone arm.

14. The phonograph system of claim 13, wherein the tone arm comprises a cross-section D-shaped carbon fiber tube.

15. The phonograph system of claim 13, wherein the interface is configured as a spherical curve.

16. The phonograph system of claim 15, wherein air flows out from the interface between the hemisphere curvature and socket curvature, whereby the thin film of air levitates the upper hemisphere bearing member and tone arm.
